(19) United States
(12) Patent Application Publication
(10) Pub. No.: US 2008/0023090 A1
(43) Pub. Date: Jan. 31, 2008

(54) Wastewater disposal mechanism for recreational vehicles

(76) Inventor: Lannie Stegall, Lexington, KY (US)

Correspondence Address: STOCKWELL & SMEDLEY, PSC, 861 CORPORATE DRIVE, SUITE 200, LEXINGTON, KY, 40503, US

(21) Appl. No.: 11/493,248

(22) Filed: Jul. 26, 2006

(51) Int. Cl. B60R 15/04

(52) U.S. Cl. 137/899

(57) ABSTRACT

A mechanism for managing the wastewater compartments of recreational vehicles (RVs) is disclosed. The mechanism reduces work and health risk associated with emptying wastewater compartments commonly found in RVs.

### FIELD OF THE INVENTION

The present invention relates to wastewater compartments of recreational vehicles (RVs), and more particularly to a mechanism which reduces work and health risk associated with emptying the wastewater compartments.

### BACKGROUND OF THE INVENTION

Most RVs have a black water and gray water waste tanks. The black tank is for sewage, while the gray tank is for shower and sink. Emptying and maintaining these tanks involves a significant amount of effort, as well as large amounts of clean water. Also, at many RV dump sites, clean water is not available. Consequently, an improved mechanism for managing these waste water tanks is desired.

### BRIEF DESCRIPTION OF THE DRAWINGS

FIG. 1 shows an exemplary embodiment of the prior art;

FIG. 2 shows an exemplary embodiment of the present invention;

FIG. 3 shows the embodiment of FIG. 1 implemented within an RV;

FIG. 4 shows an exemplary user panel employed with the embodiments of FIGS. 2 and 3;

FIG. 5 shows exemplary features of the user panel shown in FIG. 4; and

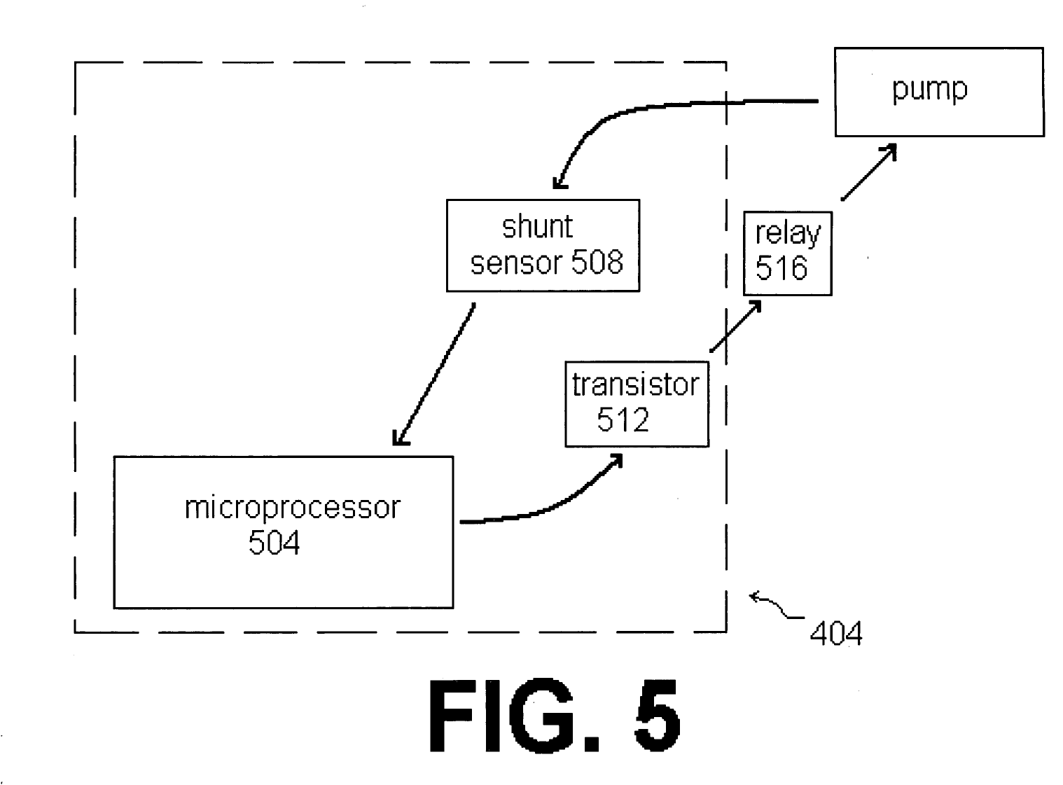

FIG. 6 shows another feature of the present invention.

### DETAILED DESCRIPTION OF THE PREFERRED EMBODIMENTS

Before explaining the disclosed embodiment of the present invention in detail it is to be understood that the invention is not limited in its application to the details of the particular arrangement shown, since the invention is capable of other embodiments. Also, the terminology used herein is for the purpose of description and not of limitation.

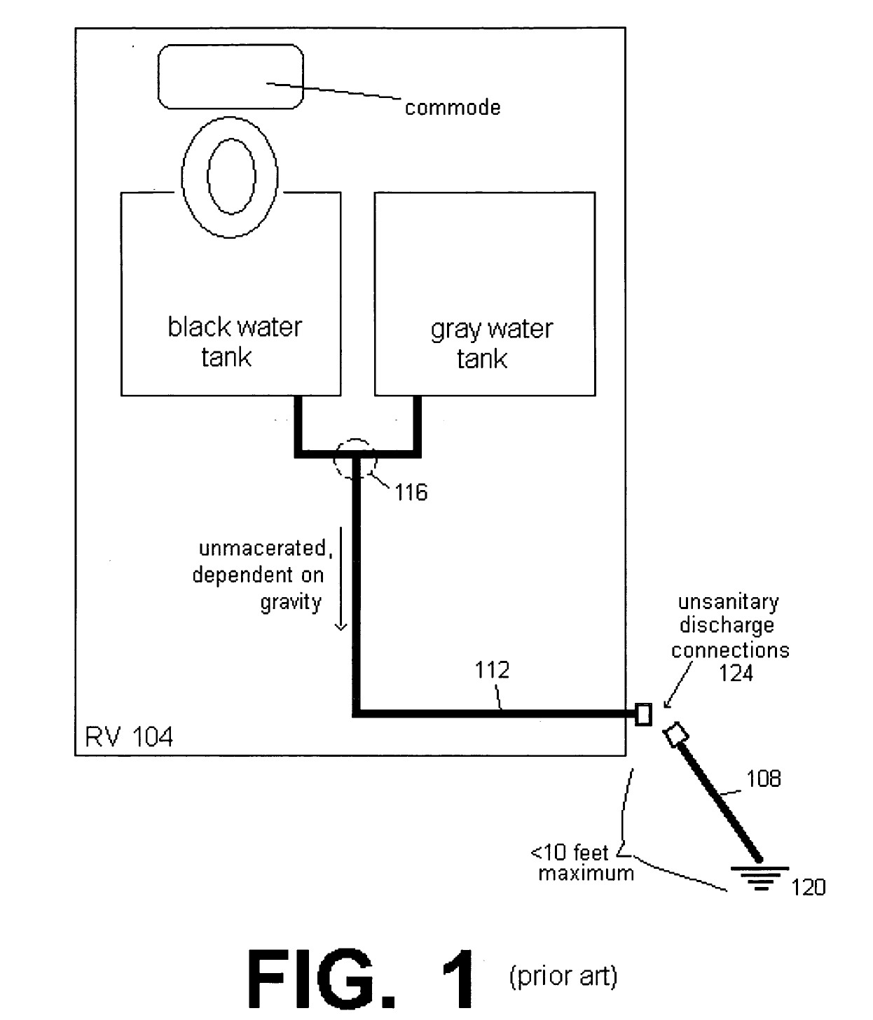

As shown in FIG. 1, both black and grey holding tanks are fitted directly onto a typical RV 104. FIG. 1 shows that the black tank is usually located directly below the toilet area, so that the waste will fall directly into the tank when the toilet is flushed. The only entry into the black tank that is not direct spill is waste that has gone through a toilet with a macerator pump (not shown) mounted into the drain of the commode. This is an unusual arrangement, seldom found in RVs, and is also not very practical.

Also as shown in FIG. 1, for the purposes of space utilization, the black and gray tanks are mounted side by side, over a fresh water tank (not shown). The stored fresh water for use in the RV is typically double the size of an individual tank. Thus, the combination of the black and gray tanks total volume will be approximately equal to the fresh water tank's total volume.

Certain details of FIG. 1 are abbreviated for clarity. However, it is well known in the RV universe that the plumbing from the black and gray tanks to the discharge connections 124 is routed through small openings, and is difficult to maintain and almost impossible to repair unless all tanks are entirely removed. This makes repair very expensive and difficult to do safely.

To clean a black tank, for example, a tank flushing head (not shown) can be mounted into the tank to spray fresh water under pressure to remove the solids that collect on the walls of the tank. This exposure to the open air when the water level in the black tank is low allows odors to be produced and vented to the atmosphere. These odors can also be pushed into the coach of the RV when the flushing of the toilet occurs. Also, when the orifices in the shower head used for flushing become clogged with sand and grit from the water sources at RV parks, the force might increase, however the benefit of the spray head is very inefficient at best. Only a small point of contact will be free of the solids when the spray is directed on the walls.

Also, improper monitoring of the process of flushing the tanks can allow hazardous material to overflow into the coach interior if the valves are not opened, or if the valves are not draining at the proper rate. Also, if the water level indicators that come with every RV fail, the only indication the black tank is full is when visual level through the open commode is possible. It is well-known that human waste clumps when introduced to cold water. Human waste also sticks to the walls and can prevent an indicator light sensor (often used within RVs) from working. Fresh water will not properly clean the grease laden walls in the black tank.

The present method of emptying the tanks on RVs has several disadvantages. First, a hose 108 must be removed from storage dark and damp, and a perfect habitat for bacteria. A user must then connect the hose 108 to a single pipe 112 that connects the storage tanks, both gray and black water, through a Y pipe 116 controlled by manual valves (not shown). The user then places the hose 108 in a waste tank receptacle 120, and then opens the valves. The user will then empty the two tanks, including unbroken solids, via gravity-only. This requires that the RV 104 be parked and located in such a way that gravity-movement is facilitated, which can sometimes be inconvenient if not outright impossible.

After emptying, the user must remove and store the hose 108. During the emptying process, the user is exposed to splashes, spills and odors due to using gravity to empty the tanks through the large diameter 3″ hose 108. This large diameter is necessary to accommodate to allow clumps of human waste, toilet tissue and any other items that have been introduced into the commode, sinks, showers and laundry to flow out by gravity.

When the hose has finished emptying the tanks, the hose 108 is removed and prepared for storage. The water stored in the tanks is hazardous material to handle and risk to contamination and exposure to disease can result. Thus, rinsing is required to prepare the hose 108 for storage, which is impossible, even if a water hose supply is available. However, in many instances, fresh water is not available at public facilities.

Further, within many existing RV configurations, if the black or gray tanks become unusable due to clogged lines in the downstream or connecting plumbing, it is very difficult to remove the clogging material or the tanks if they are filled. When servicing the tanks or repairing the plumbing, the exposure to disease and harmful bacteria is high. Also, the conventional valves widely used within the RV industry (not shown) are inadequate to properly close the flow if solids or paper is allowed to stick in the sides of the gate valves. Thus, clogged lines and valves are very common in the RV industry.

To open the clogged lines, a flexible steel line must be rammed up the line and when this method is successful, the rushing sewage often moves faster than the user can get out of the way. In such a circumstance, the potential exposure to disease is significant.

The amount of clean treated water that is used to flush through the flush ports found on all black and grey tanks is typically much more than the amount of water that is flushed through the toilet. This is because most RV commodes are designed to empty with only a small amount of clean treated water.

However, despite this attempt at efficiency of use of water, in common practice an RV owner may use cleaning volumes that are equal to two and three times the capacity of a black or gray tank. This is an inefficient use of the drinking water supply which the present invention seeks to reduce.

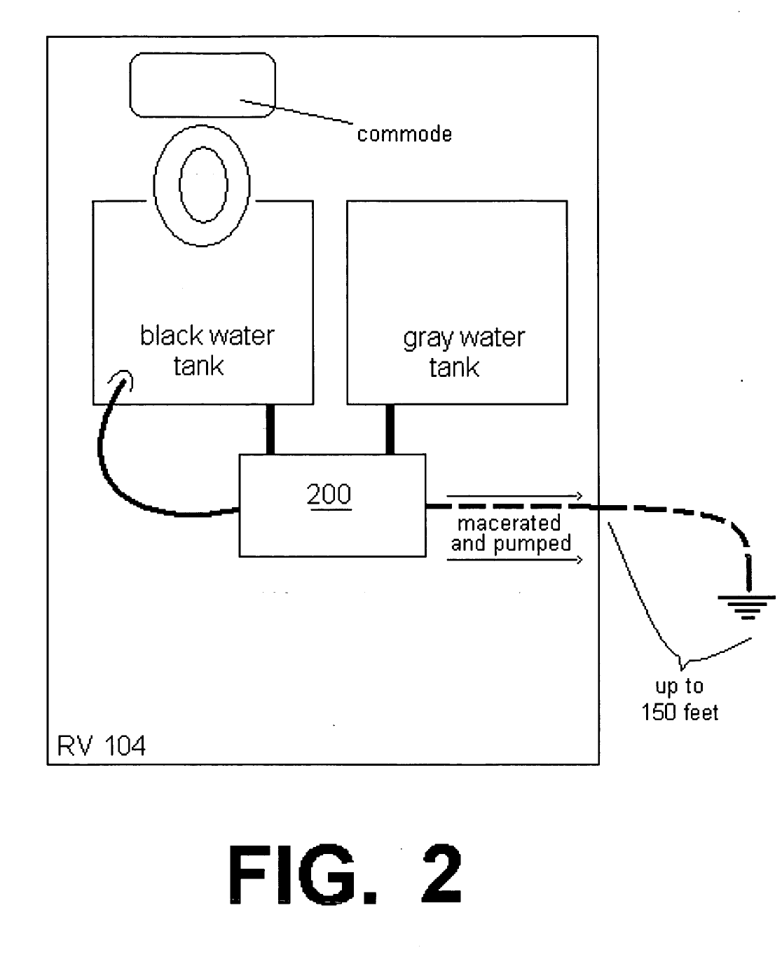

To address these concerns, FIG. 2 shows an exemplary embodiment of the present invention. As shown in FIG. 2, the present invention simplifies the plumbing situation present in typical RVs. From FIG. 1 it is apparent that, as stated, in a conventional RV, the distance between the black and gray tanks and the (downstream) discharge tube available to a user is lengthy. This is even more of a problem in larger RVs. Thus, a lot of clogs and jams can happen in the downstream plumbing, and occur in an area that is not readily user-accessible.

Meanwhile, FIG. 2 shows an RV 104 with the control system 200 of the present invention implemented therein. From FIG. 2. it is apparent that the amount of downstream plumbing is reduced from FIG. 1. Reducing downstream plumbing from the tanks to the discharge tube and hose will make it easier to maintain and service the system. Also, service related technicians will not be exposed to the conditions presently involved in unclogging plumbing lines. Further, an RV owner operator is removed from the waste control process of the old hose.

Within the existing RV universe, the purpose of the two tank (black and gray) holding tank system is designed partly for user convenience. Sanitation statutes regarding waste disposal allow a user to empty their gray water onto any ground surface, as long as it is not co-mingled with black water. The present invention takes advantage of this feature to find a useful purpose for the otherwise unwanted gray water. That purpose is to rinse the black tank. This is a significant improvement over using clean water to rinse the black tank, as is presently necessary within most RVs. Also, clean water by itself, in the absence of detergent or soap normally present in gray water, is not suitable for cleaning the walls and floors of holding tanks.

Accordingly, within the present invention, as shown in FIG. 2, gray water, though hazardous to handle, can be routed through the black tank at the user's choice. This provides a secondary use of the contents of the gray tank, which otherwise has no value whatsoever.

Another problem solved by the present invention is that presently, gravity is necessary to empty both black and gray water tanks of a typical RV. Most RVs have gravity waste systems. However, RVs with gravity waste systems depend on public and private facilities to empty the tanks. The number of facilities available to the public is decreasing due to the high cost of maintenance and waste water treatment. This will cause an increase in the amount of sewage that is dumped onto public lands. Unfortunately, this eliminates the ability to empty these tanks anywhere except into receptacles that are lower than the opening of sewer pipe that exists underneath a typical RV. For example, the state of Illinois has a restriction that all receptacles at RV parks that are sited in a flood plain must be 18″ above the adjacent soil. This makes emptying the tanks by gravity impossible for most RVs.

The inadequate process of the gravity method of emptying the tanks is readily recognized due to the increase in demand for horse trailers that have sleeping quarters, fresh water storage and holding tanks for both black and gray water. The layout of the tanks and plumbing indicate additional problems as a result of the low frame height of a horse trailer, for example. Within a typical horse trailer, all of the water tanks, fresh, black, and gray are located in the space of the floor joist which is about 6″ ground clearance. Because of this low ground clearance, plumbing to control and permit the discharge of the tanks is easily knocked off or torn loose when the tow truck and the trailer span a higher obstacle.

Also, because of the minimal ground clearance, the assistance from gravity which is necessary to move the water and solids is minimal at best. Thus, the present method of storing and emptying the tanks is onerous and unsafe. It is not very predictable and introduces many different opportunities for mistakes and operator error.

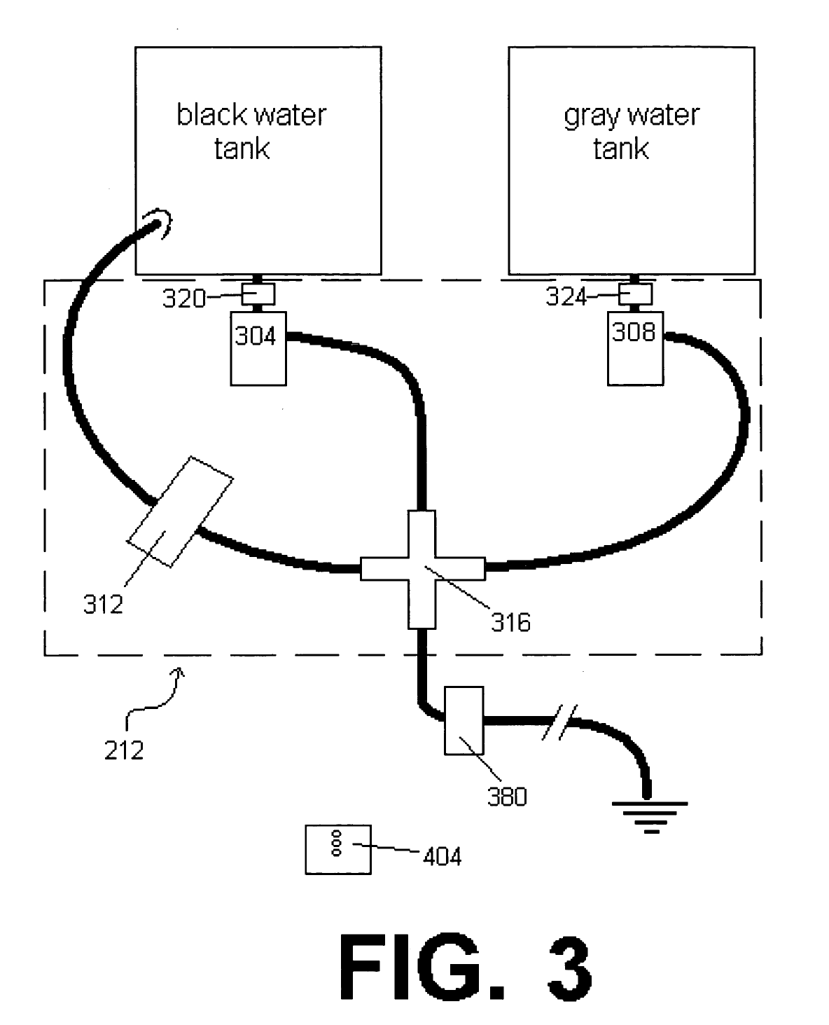

The present invention addresses all of the above problems, and also eliminates most of the servicing problems associated with holding tanks. From FIG. 2 it is apparent that the discharge from the RV 104 utilizing the control system 200 of the present invention is pumped and not merely drained by gravity. Additionally, as shown in FIG. 3, the holding tanks are each connected to a gate valve 320, 324 that are normally left open during use, and are only closed for maintenance. Flow will pass through the open gate valves and directly into the inlet of a macerator-transfer pump 304, 308 on each tank that is rated, for example, at 12 volts 20 amps. Although a 12 volt 20 amp pump is suggested, this is but for exemplary purposes only, so that the pumps within the present invention should not be considered as limited exclusively thereto. These pumps act as a normally closed valve when power is turned off, which is redundant to the shut-off protection accorded by the gate valves 320, 324.

When the tanks need to be emptied, power is furnished to motors within the macerator-transfer pumps 304, 308 so that a semi-liquid flow results. In the event of a requirement to remove and replace a macerator-transfer pump, the gate valve corresponding to that tank can be manually closed to eliminate any unexpected flow or volume. When the replacement of a macerator-transfer pump is completed, the gate valve or valves can be reopened, and normal operation resumed.

The pumps 304, 308, gate valves 320, 324, and valve 312 are accessible through a covered service area that is commonly found at the side of most RVs. An RV owner can thus perform a limited amount of self-repair of the control system 200 of the present invention. One such possible repair would be to remove and unclog the pump, in case some type of hardened plastic or metallic object got jammed therein. This accessibility would be useful in the event of a clogged pump would not require an RV user to cancel the trip and take apart the control system 200 and send it to an authorized repair facility.

The water from the tanks is suctioned out of the tanks and passed through the macerator-transfer pumps 304, 308. This step is taken so that the solid waste can be converted into a liquid stream by the macerator-transfer pumps 304, 308 and then introduced into a ¾″ or larger discharge hose. This is a significant improvement over the prior art, which required hoses having a minimum a 3″ diameter. Having smaller diameter hoses takes up significantly less space, and is also easier to maintain, clean, add attachments, and find spare parts.

The discharge hoses, of whatever size, from the macerator-transfer pumps 304, 308 will be connected to the first and second legs of a 4-way “T” valve 316. This will allow the discharge to be transferred to a legal receptacle through a third leg of the T-valve 316, either above or below the elevation of the discharge opening of the tanks. The nozzle on the end of the discharge hose flowing to the ground receptacle can be equipped with threads or couplings that will allow additional hoses to be installed. This is convenient because the discharge can then be conveyed great distances from the RV such as greater than 150 feet. Conversely, existing implementations of RVs require the RV to be pulled very close to the sewer tank input line.

As shown in FIG. 3, the fourth leg of the T-valve 316 would be used to convey contents of the gray tank into the black tank. However, this operation cannot be performed unless a rinse valve 312 that is left normally closed and opened only when the rinse-black-using-gray-water process is safe to perform. The actuation of the rinse valve 312 will also turn on the black tank macerator-transfer pump 304 which will remove the volume that is being sent to the black tank from the gray tank.

Actuating the rinse valve 312 can be done manually by the user, but can also be a mechanized portion of the control system 200. In the instance where the rinse valve 312 is manually operable, after completion of a gray-to-black rinse, a user could mistakenly forget to close the rinse valve 312. That user may then think she is emptying gray water into ground. Instead, that gray water may be flowing into the black tank, which may not have the capacity to store the volume of incoming gray water. This can result in a situation where the black-water tank eventually overflows through, for example, the commode, and then into the interior of the RV.

To address this, the control system 200 is equipped with sensing mechanisms (not shown) which can detect the available storage capacity of the various tanks, and also can detect whether the tank levels are rising or falling, at what rate, and whether they are near to overflowing. At such an instance, the control system 200 could force a shut-off of the pumps 304, 308, alert the user through the console 404 such as but not limited to blinking various of the LED lights, thereby allowing a user to take corrective action such as but not limited to manually closing the rinse valve 312 and re-starting the emptying process.

FIG. 3 also shows a last valve 380, which is so named because it is the last valve before the contents of the tanks get entirely emptied from the RV 204. In one embodiment of the present invention, the valves 312 and 380 are always in opposite positions. This way, if a user elects to rinse the black tank using gray contents, the last valve 380 should remain closed. This is because the user can not be intending to utilize the external drain while simultaneously performing a gray-black rinse. Similarly, if the user is using the external drain and therefore opening the valve 380, then the valve 312 should be closed as the user will not rinse the black tank at the same time as emptying. Such a “radio button” configuration of valves 312/380 could be achieved using, for example, a spool mechanism.

The need to use clear treated water to flush and clean the blank tank will be eliminated by the use of gray water which normally contains at least some soap, detergent and surfactants. The present invention can control the flow of effluent from the tanks to the sewers. Because it is not gravity-dependent, the control system 200 of the present invention can manage this flow regardless of whether the destination sewer is above or below the level of the openings of the black and gray tanks.

In an alternate embodiment of the present invention, the valve 312 is operated entirely by the control system 200, so that direct no user interaction with the valve 312 is required of a user. In yet another alternate embodiment, a single-motor embodiment exists in which one motor supplies power to both the black water and gray water macerator-transfer pumps 304 and 308.

Also, regardless of whether a single motor or a group of motors is used, the motor(s) will be controlled by user-operated buttons on the console of the central control unit 404. The various motors or single motor can be turned off by the control system 200 when the current required to run the pumps falls to a level that would indicate that liquid is no longer available to be pumped. This prevents damage to the pumps 304, 308 that may occur from their being activated while liquid is no longer available. However, as long as a load exists, requiring the pump to operate to empty to volume, power will be furnished to the pump.

Another feature provided by the control system 200 is the ability to sense the difference in the amount of current drawn by the pumps 304, 308, and take preventative action to prevent burning out of one of the pumps. However, when one pump is newer while the other pump has been installed for a long time, some disparity in the amount of current drawn is not only acceptable but is to be expected. Accordingly, to avoid false-alarm shutdowns of the pumps 304, 308 when there is no risk of harm or burning out, the control system can either be manually calibrated but also can self-calibrate, such as but not limited to every time it is activated or “booted up”.

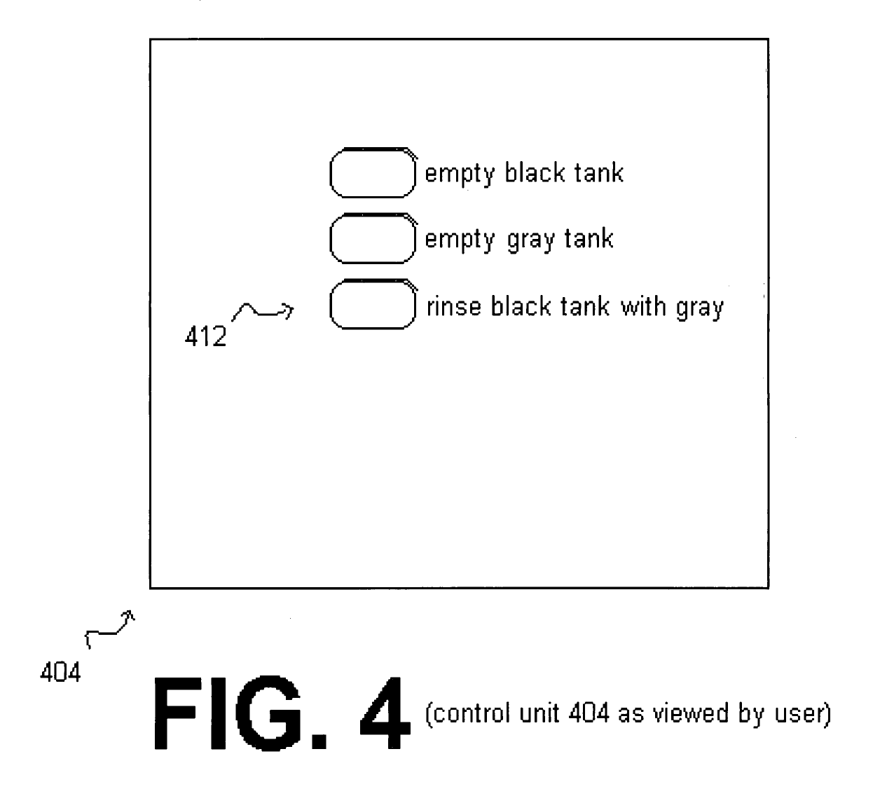

FIG. 4 shows the control unit 404 of the present invention. The embodiment shown in FIG. 4 is for exemplary purposes only, so that the present invention should not be considered as limited exclusively thereto. From FIG. 4 it is apparent from the three buttons that in an exemplary embodiment, a user can elect to empty a gray tank, empty a black tank, or rinse the black tank using contents of gray tank. An indicator light incorporated within the button can show the user that a specific choice has been implemented. However, other user interfaces are contemplated within the spirit and scope of the present invention. For example, although not shown in FIG. 4, the control unit 404 could enable a user to scroll through various options by pressing an up-down arrow, and then make a choice by pressing an enter key.

As shown in FIG. 4, indicator lights will be used to show the status of the run or idle condition of the various motors and pumps. For example, the central control unit 404 will give at least the following choices 412 to an operator:
black tank emptying;
gray tank emptying; or
black tank being rinsed with water from the gray tank.

Other choices are also contemplated within the spirit and scope of the present invention, so that the present invention should not be considered as limited to the implementation shown in FIG. 4. As shown in FIG. 4, when a user selects a process, a green light on the central control unit 404 can indicate that a process is under way. A yellow light can show when all processes are completed. Some other color can be used to show that a pump or pumps are running. The lights can be incorporated into the buttons of the control unit 404, or can be separated.

Another advantage of the present invention is in its water conservation. Re-using the gray water to rinse and flush the black-water tank means that an RV can be parked in a single place for longer times. One example of this is an RV visiting a residential setting. Often, a guest visitor will park their RV at someone's driveway, and then sleep in the RV. They may also take a shower in the RV in the morning. However, that guest may also spend time with their host, go places together, plus be in the house together including using the commode in the house (rather than the commode in the RV). Under these circumstances, within the RV the gray water tank may fill at a significantly faster rate than the black water tank. Thus, the gray water tank may need emptying long before the black water tank. It is considered a discourtesy to empty a gray water tank into someone's driveway. Thus, having the ability to empty at least part of the gray water tank into the black water tank could mean that a person could stay longer in a driveway, without the need to move their RV.

Another advantage of the present invention is its autonomy. Because the central control unit 404 can reliably monitor the pumps, valves, and direction of flow of various liquids and semi-liquids, an operator is not be required to stand by during a flushing, rinsing, or emptying process. Also, as stated, if it is necessary to make repairs to the control system 200, the pumps 304, 308, gate valves 320, 324, and valve 312 are accessible to a user without removing any other parts, through the covered service area on the side of most RVs.

To install the present invention, both black-water and gray-water tanks must be completely empty. Next, the installer must remove whatever covers or screens which impeded a user from getting at the RV tanks. This is because the installer must have access to the threaded output spigots of both black-water and gray-water tanks.

The installer then removes the hoses connected to the threaded output spigots. The installer then connects specialized valves and pumps pre-configured to correspond to specific types of RVs (e.g. RASCAL™, PROWLER™, other brands, etc) to those output spigots. Afterwards, the user must connect the central control module to the pumps, valves, and also battery leads.

The present invention must be tested during the installation process, to make sure all portions behave in a way that makes sense. As stated, to install the present invention, it is necessary that all tanks be empty. However, that was only at the very beginning of the mechanical equipment phase, when hoses are being loosened and then re-attached. During installation, which is a one-time only process that will not require repeating, a sample load of water will be useful in testing the proper installation and behavior of the present invention.

The present invention will cause a beneficial change in the cost to build, operate, and maintain the tanks on an RV. It will also increase operator safety and water conservation. This is at least partly because the requirement for gravity is eliminated in the process of emptying the tanks on RV's, thereby increasing safe conveyance of hazardous materials to proper receptacles. Also, the operator will not be exposed to the waste discharge of the tanks.

Other features of the present invention could also include a means for tracking the flow and volume of each pump 304, 308. During a rinse-black-with-gray-contents operation, it is especially important that the gray pump 308 detect that the black tank is full and then automatically shut off, rather than overfill the black tank. It is possible that the black tank may not have the space to absorb the entire contents of the gray tank. One reason for this could be that the two tanks may not be the same size.

Instead, shutting off the gray pump 308 based on an “all full” signal from the black tank removes the risk of over-filling the black tank. However, the instruments which determine whether a tank is full or not can be difficult to install and maintain, and also suffer from reliability problems and “false alarms”.

Instead, another precaution might be to measure the flow and volume of the pumps 304, 308. One way to obtain this information might be to measure and store the total revolutions of their motors, although the present invention should not be considered as limited exclusively thereto.

This measurement could insist in determining how much contents the black tank has recently discharged. Thus, if the black pump 304 has run a certain amount of rotations, than the gray pump 308 would be forced to shut off when it reaches that amount of rotations.

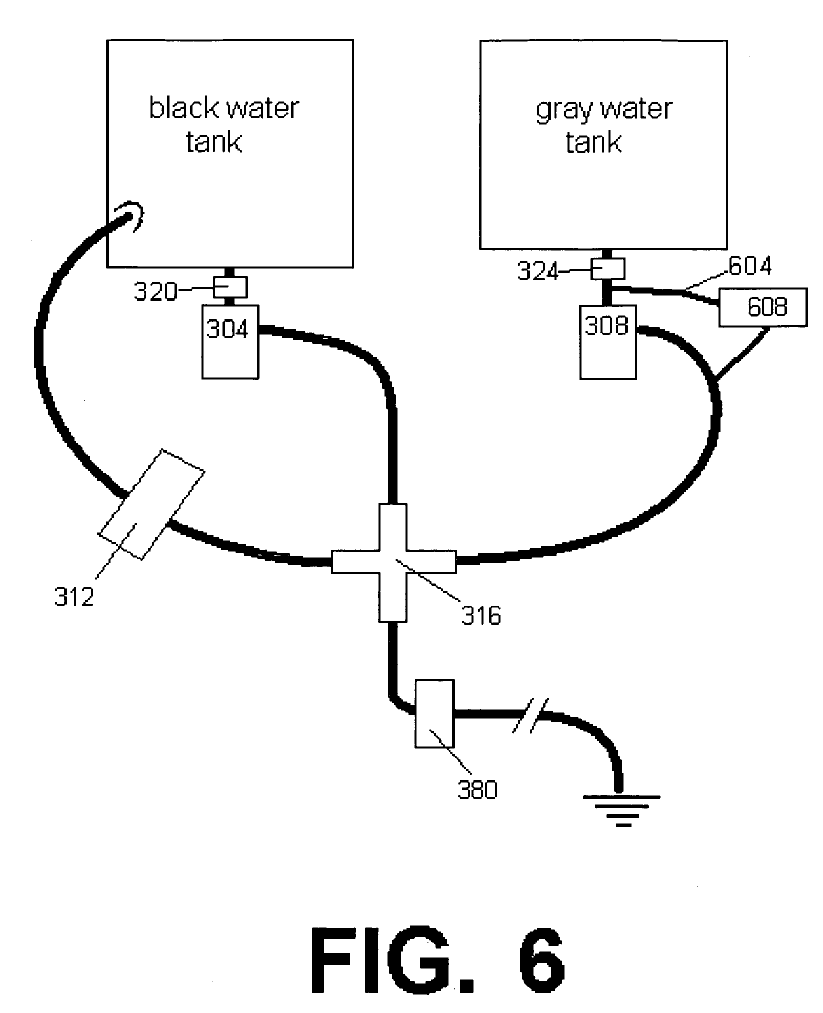

Another variation of the present invention is shown in FIG. 6, and involves a gray water bypass 604. RV users will note that there may be instances in which it is possible to drain the gray tank without running any motors or pumps whatsoever. Another instance might be where it is desired to not use electrical or battery system of the RV. In these and other cases, the gray tank can be emptied without activating pump 308 or valve 324. Instead, as shown in FIG. 6, a manually operated valve 608 can be opened, and the gray tank can be emptied.

The various aspects of the present invention has been described in detail with particular reference to preferred embodiments thereof, but it will be understood that variations and modifications can be effected within the spirit and scope of the invention as described herein. It is anticipated that various changes may be made in the arrangement and operation of the system of the present invention without departing from the spirit and scope of the invention, as depicted in the following claims.

What is claimed is:

1. A device for managing flow of wastewater in recreational vehicles, comprising:
a central controlling mechanism for accepting and activating user choices;
a plurality of macerator-transfer pumps under the control of the central controlling mechanism and connected to black water and gray water tanks of an RV;
a plurality of shut-off valves under the control of the central controlling mechanism, connected between each of said tanks and each of the macerator pumps;
a rinse valve located between the gray and black water tanks, for selectively routing contents of the gray tank into the black tank; and
a four-way joint connection wherein two of the connections are attached to the outputs of the macerator pumps, one of the connections is attached to a discharge hose for evacuating the wastewater, and one of the connections is attached to the rinse valve.

2. The device of claim 1, wherein the rinse valve is manually operated and not under the control of the central controlling mechanism.

3. The device of claim 1, wherein the rinse valve is under the control of the central controlling mechanism.

4. The device of claim 1 being accessible through a covered service area that is commonly found at the side of most RVs

5. The device of claim 1, wherein the discharge hose is three-quarter inch in diameter.

6. The device of claim 1, wherein wastewater is conveyed greater than 150 feet from the RV.

7. The device of claim 1, further comprising:
sensing mechanisms attached to either the black tank, gray tank, or both tanks, for detecting the available storage capacity of the tanks.

8. The device of claim 1, wherein the sensing mechanisms can detect whether the tank levels are rising or falling, at what rate, and whether the tanks are close to overflowing

9. The device of claim 1, last valve before the contents of the tanks get entirely emptied from the RV

10. The device of claim 1, rinse valve and last valve are always in opposite positions.

11. The device of claim 10, wherein said opposition achieved using a spool mechanism.

12. The device of claim 1, single-motor embodiment exists in which one motor supplies power to both the black water and gray water macerator-transfer pumps

13. The device of claim 1, further comprising:
a user-operated console mechanism for operating the central controlling mechanism system, having buttons for accepting user input and indicator lights for indicating which functions have been accepted.

14. The device of claim 13, further comprising:
the central controlling mechanism having means to force a shut-off of the plurality of macerator-transfer pumps and alert a user through the console.

15. The device of claim 14, further comprising:
blinking various of the indicator lights to alert a user of specific events.

16. The device of claim 1, further comprising:
means for sensing the difference in the amount of current drawn by the pumps and take preventative action to prevent burning out of one of the pumps

17. The device of claim 1, further comprising:
the central control system can either be manually calibrated but also can self-calibrate, such as every time it is activated.

18. The device of claim 1, further comprising:
means for measuring the flow and volume of the plurality of macerator-transfer pumps.

19. The device of claim 18, wherein the means for measuring is to store the total revolutions of motors belonging to the macerator-transfer pumps.

20. The device of claim 1, further comprising:
a gray water bypass connected between the gray tank and the four-way valve, for draining the gray tank without running any motors or pumps and not use electrical or battery system of the RV.

21. The device of claim 20, further comprising:
a gray water bypass valve, connected to the gray water bypass.

22. A method for managing flow of wastewater in recreational vehicles, comprising:
activating a central control mechanism;
viewing a user-console;
making a selection to either empty a tank or rinse a tank using the user-console;
configuring a plurality of valves;
activating a plurality of macerator-transfer pumps; and
discharging wastewater.

23. The method of claim 22, further comprising:
forcing a shut-off of the plurality of macerator-transfer pumps; and
alerttng a user through the user-console.

24. The method of claim 23, further comprising:
blinking various indicator lights within the user-console to alert a user of specific events.

25. The method of claim 22, further comprising:
sensing the difference in the amount of current drawn by the plurality of macerator-transfer pumps; and
taking preventative action to prevent burning out of one of the pumps.

26. The method of claim 22, further comprising:
manually calibrating the central control mechanism.

27. The method of claim 22, further comprising:
the central control mechanism self-calibrating, such as every time it is activated.

28. The method of claim 22, further comprising:
measuring the flow and volume of the plurality of macerator-transfer pumps.

29. The method of claim 28, further comprising:
storing the total revolutions of motors belonging to the macerator-transfer pumps.
